(19) United States
(12) Patent Application Publication
(10) Pub. No.: US 2008/0053361 A1
(43) Pub. Date: Mar. 6, 2008

(54) SIDE RIGGER FOR FISHING BOAT

(76) Inventor: Paul D. Nicholson, Clayton, NC (US)

Correspondence Address: PHILIP D FREEDMAN PC;PHILIP D FREEDMAN, 317 S. FAYETTE STREET, ALEXANDRIA, VA, 22314-5902, US

(21) Appl. No.: 11/934,124

(22) Filed: Nov. 2, 2007

Related U.S. Application Data
(62) Division of application No. 11/289,173, filed on Nov. 29, 2005.

(51) Int. Cl. A01K 97/10; B63B 17/00

(52) U.S. Cl. 114/364; 248/514

(57) ABSTRACT

An adjustably mounted side rigger for use on a fishing boat that tends fishing line from a fishing rod outward from the boat during trolling. The side rigger extends a fishing line to the side of the boat during trolling in order to prevent the line from entangling with other trolling lines originating from the boat. The side rigger contains a rod holder base adapted to fit inside an existing rod holder on a fishing boat for portability, flexibility of use, and lower cost than a traditional outrigger. The rod holder base and a telescoping pole mounted to the side rigger that extends the fishing line outward from the boat, are both adapted to be rotated or swiveled by a user to allow the side rigger to be used on either side of the boat and used in a variety of different angled and positioned fishing boat rod holders for maximum flexibility.

### FIELD OF THE INVENTION

A adjustably mounted side rigger that contains a rod holder base adapted to fit inside an existing rod holder on a fishing boat, wherein the rod holder base and a telescoping pole mounted to the side rigger are both adapted to be rotated or swiveled by a user to allow the side rigger to be used on either side of the boat and used in a variety of different angled and positioned fish boat rod holders for maximum flexibility. The side rigger extends a fishing line to the side of the boat during trolling in order to prevent the fishing line from entangling with other fishing lines originating from the boat.

### BACKGROUND OF THE INVENTION

Many people engage in sport fishing. Depending on the species of fish being sought, different methods are employed to catch such fish. For example, certain types of game fish are predators and are more attracted to moving fish or bait in the water rather than stationary bait. For these type of game fish, trolling is often employed as the preferred method to attract and catch these game fish.

Trolling consists of placing fishing lines from one or more fishing rods on the boat in the water and the boat moving slowly forward to drag the bait in the water to attract fish. The bait that is placed on the fishing line can be either live, dead, or artificial bait depending on the species fish being sought and conditions. The trolling speed also depends on the species of game fish being sought and whether or not live bait is used. If live bait is used, then trolling speeds may be slower so as to keep the bait alive.

Because of the different characteristics and habits of fish and weather and water conditions, multiple fishing lines are usually let out of the boat to increase the chances of catching fish. Some of the fishing lines may contain live bait and some may contain dead bait. Use of different kinds of bait is a well-known technique to improve the chances of catching the desired fish since fish sometimes are attracted to one kind of bait more than another depending on various factors. It may also be desirable to use a downrigger on some fishing lines to take the bait down to a certain depth in the water since some fish may be more attracted to bait at a lower depth than on or near the surface of the water. In any event, the more fishing lines that are placed from the boat in the water, the greater chance of success.

Because a sport fishing boat is usually of limited size, if too many fishing lines are placed in the water, the lines can become tangled. The tangling can occur from either the boat turning, currents, or if live bait on lines moves too close to other lines thereby causing the lines to entangle with each other. Live bait tends to be attracted to other live bait to travel together thus increasing the chances of entangled lines. Thus, an outrigger can be employed to place fishing lines out from the side of the boat to spread the lines farther from each other and from the lines that are cast out directly from the back of the boat. In this manner, more lines can be placed in the water and thus the chance of success in catching the desired fish usually increases without as much risk of entanglement.

One problem with outriggers is that they are expensive and bulky, and require permanent mounting to the boat. Smaller boats in particular do not use outriggers because of their size and/or expense. However, smaller boats still compete in sport fishing and related tournaments, and most tournaments even have separate competitions in which only smaller boats compete because of a variety of disadvantages from larger boats. However, if outriggers are not employed, this limits the number of lines that can be placed in the water for fishing, and thus reduces the chance of success of a smaller boat catching a fish as opposed to larger boats that employ outriggers.

Thus, a needs exists to provide a simple, portable, and inexpensive rigger to allow boats to extend fishing lines to the side of the boat to reduce entanglement of lines, and so that a traditional expensive and bulky outrigger does not need to be employed. Smaller boats that typically cannot or do not want to employ outriggers due to their size and cost, would benefit from the present invention.

### SUMMARY OF THE INVENTION

The present invention is a side rigger for extending a fishing line to the side of a boat during trolling. The side rigger contains a rod holder base adapted to mount in an existing fishing rod holder on a boat. In this manner, the side rigger is portable, small, and inexpensive. The side rigger contains two additional rod holders so that up to two more fishing rods may be placed onto the side rigger when in use, since the side rigger has eliminated use of a fishing rod holder on the boat when installed.

The side rigger consists of an adjustable telescoping pole so that the fishing line can be extended away from the boat when trolling. The telescoping pole is mounted to a variably adjustable mount so that the telescoping pole can be rotated outward up to ±approximately 90 degrees to extend the pole outward from the boat at different and desired angles, and so that the side rigger can be used on either side of the boat to extend the fishing line.

The side rigger also contains a swivel mount for the rod holder base so that the orientation of side rigger can be adjusted depending on the fish rod holder orientation on the boat to keep the platform of the side rigger level, since rod holder designs and orientation angles differ from boat to boat. In this manner, the user of the side rigger can keep the platform of the side rigger in the desired position regardless of the varying designs and orientation angles of fishing rod holders on fishing boats.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 is an illustration of the side rigger in accordance with the present invention mounted in the rod holder on a boat;

FIG. 2 is an illustration of a typical fishing boat employing the side rigger mounted in a fishing rod holder on the boat in accordance with the present invention;

FIG. 3 is a break-out illustration illustrating the components of the side rigger and how they connect together;

FIG. 4 is an illustration of the side rigger illustrated in FIG. 3, but completely assembled;

FIGS. 5A-5B are front view illustrations of the side rigger showing the rod holder base rotated to the left (FIG. 5A) or to the right (FIG. 5B) with respect to the side rigger platform to alter the mounting angle of the side rigger to the fishing rod holder so that the side rigger can be used with different angled rod holders mounted on the boat and attempt to keep the platform level;

FIG. 6 is an illustration of the side rigger with the telescoping pole extended and in use; and

FIG. 7 is a rear view illustration of the side rigger illustrating the adjustable clamp for extending the telescoping pole outward from an upward position to any position ±90 degrees.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention is a side rigger for extending a fishing line to the side of a boat during trolling. The side rigger contains a rod holder base adapted to mount in an existing fishing rod holder on a boat. In this manner, the side rigger is portable, small, and inexpensive. The side rigger contains two additional rod holders so that up to two more fishing rods may be placed onto the side rigger when in use, since the side rigger has eliminated use of a fishing rod holder on the boat when installed. The side rigger consists of an adjustable telescoping pole so that the fishing line can be extended away from the boat when trolling. The telescoping pole is mounted to a variably adjustable mount so that the telescoping pole can be rotated outward up to ±approximately 90 degrees to extend the pole outward from the boat at different and desired angles, and so that the side rigger can be used on either side of the boat to extend the fishing line. The side rigger also contains a swivel mount for the rod holder base so that the orientation of side rigger can be adjusted depending on the fish rod holder orientation on the boat to keep the platform of the side rigger level, since rod holder designs and orientation angles differ from boat to boat.

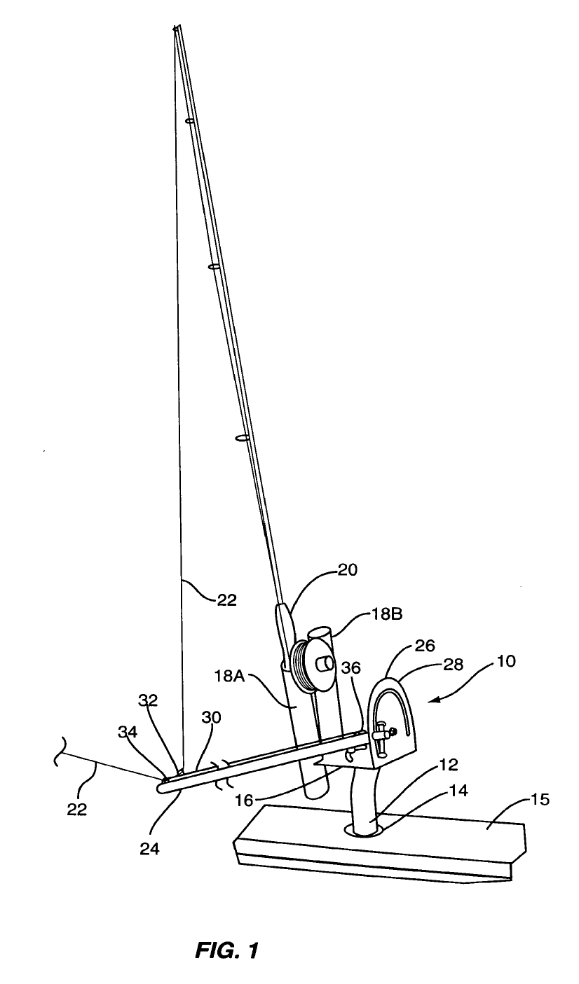

FIG. 1 illustrates a side rigger 10 in accordance with one embodiment of the present invention. In general, the side rigger 10 consists of a rod holder base 12 that is adapted to mount into the inside of a fishing rod holder 14, typically built into the top of the hull of a boat 15 on most sport fishing boats. The rod holder base 12 supports the side rigger 10 when in use. The rod holder base 12 is attached to a platform 16 that supports other components of the side rigger 10. Two additional rod holders 18A, 18B, are mounted to the platform 16 to support the addition of two additional fishing rods. As illustrated in FIG. 1, one fishing rod 20 is installed in the rod holder 18A. The fishing rod's line 22 is extended from the side of the boat 15 using the side rigger 10.

A telescoping pole 24 is mounted to the platform 16 via a variably adjustable pole mount 26. The adjustable pole mount 26 is typically attached to the platform 16 on its end at approximately perpendicular or 90 degrees, so that the telescoping pole 24 can be rotated in a plane substantially perpendicular to the surface of the platform 16 about a pole mount grooved orifice 28 built into the adjustable pole mount 26 to move the telescoping pole 24 from an upright position approximately ±90 degrees to the left or right to extend the pole 24 out from the boat 15. The grooved orifice 28 may be of any circumference as long as it allows some degree of movement or rotation. In this manner, when the fishing rod line 22 is attached to the pole 24, the fishing rod line 22 is extended outward from the side of the boat 15 to prevent entanglements, as previously discussed in the “Background of the Invention” section. A fastener (not illustrated in FIG. 1) is used to connect the pole 24 to the adjustable pole mount 26 to rotate the pole 24 to the desired position and to then tightly fasten the pole 24 to the pole mount 26 in the desired position for use. This is important so that the pole 24 can be rotated in both right and left of center of the pole mount grooved orifice 28 in the pole mount 26 so that the side rigger 10 can be used on either side of the boat 15. The pole 24 needs to be rotated to the right of center when used on the right side of the boat 15, and left of center when used on the left side of the boat.

In order to attach to the fishing rod line 22 to the telescoping pole 24 to extend the fishing rod line 22 out from the boat 15 as illustrated in FIG. 1, the line 22 is attached to a close-pin type loop line 30 via a breakaway type clamp or fastener 32. The pole loop 30 runs between two eye-loops 34, 36 mounted permanent on each end of the telescoping pole 24. When it is desired to extend the fishing line 22 outward, the fishing line 22 is attached to the loop line 30, via the clamp 32, and the line 30 is pulled, thereby moving the loop line 30 between the eye holes 34, 36 and extending the clamp 32 and line 22 outward towards the end of the pole 24 towards the outside eye hole 34. In this manner, the line 22 is attached to the loop line 30 when in reach of persons on the boat 15, but then extended outward from the boat 15 during trolling to extend the line 22 from the boat 15. The clamp 32 is releasable when a force is placed on the line 22, such as when a fish attacks the bait on the end of the line 22, or when the person holding the fishing rod 20 jerks upward on the line 22, so that the line 22 is detached from the loop line 30 and the fish can be reeled in as normal when a fish strike occurs.

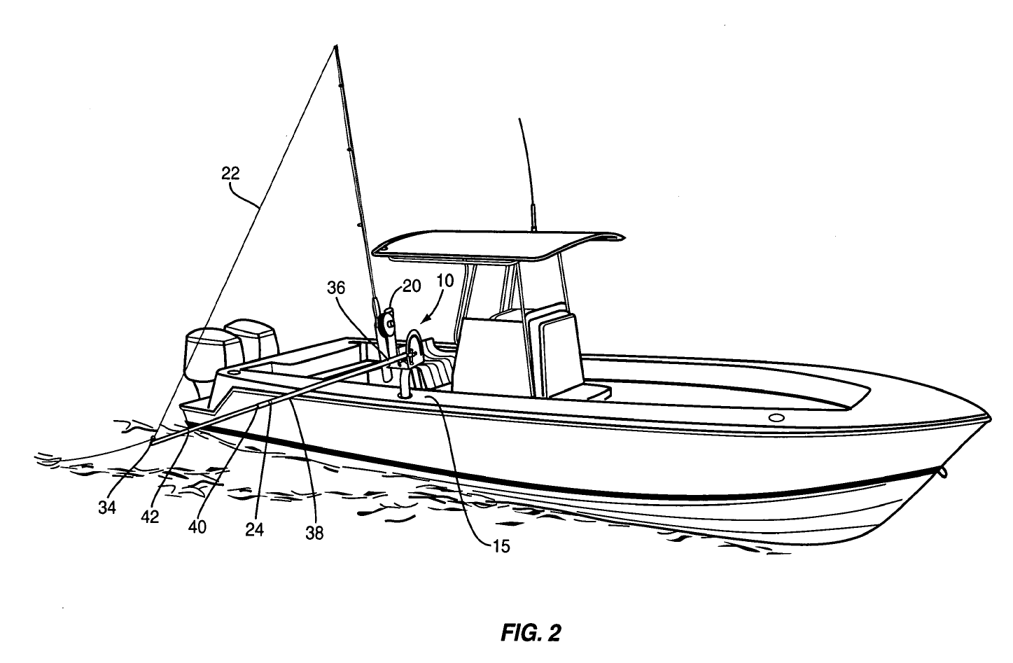

FIG. 2 illustrates a typical sport fishing boat 15 employing the side rigger 10 in accordance with the present invention. As seen from FIG. 2, the entire telescoping pole 24 is shown in extended form, and the line 22 is seen extending outward from the boat 15 as desired. The telescoping pole 24 consists of an outer conduit 38 containing an inner conduit 40. The inner conduit 40 contains the outward eye loop 34, and the outer conduit 38 contains the inner eye loop 36. The inner conduit 40 extends outward at the far end of the outer conduit 42. More detail on the telescoping design of the pole 24 will be described below.

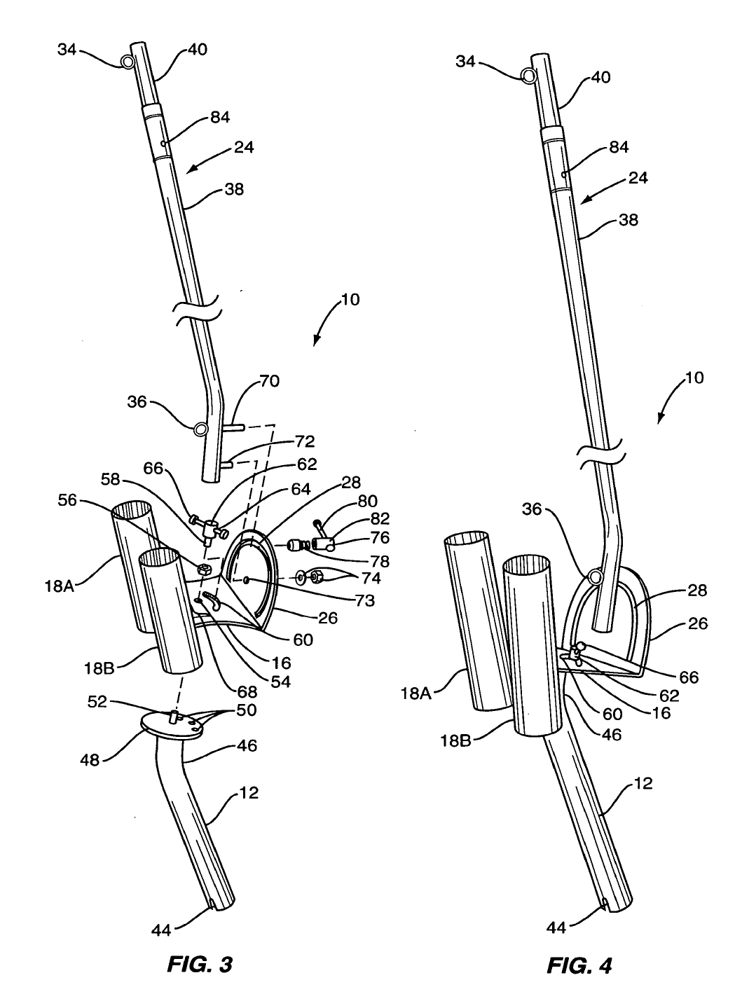

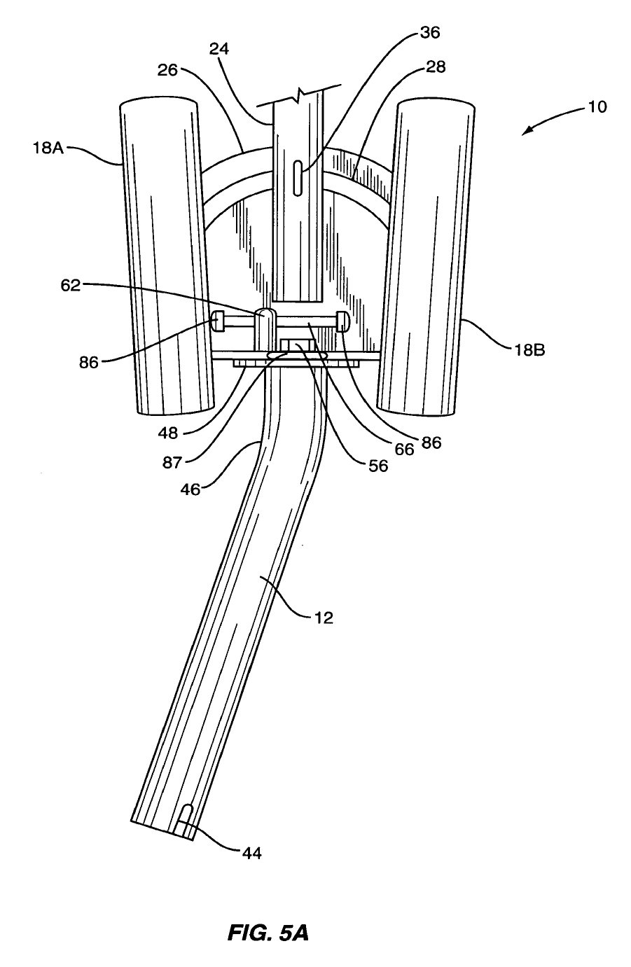

FIGS. 3 and 4 illustrate in more detail the individual components that comprise the side rigger 10. FIG. 3 illustrates a break-out view of the individual components of the side rigger 10 in an unattached form. FIG. 4 illustrates the side rigger 10 completely assembled with all components attached.

As illustrated in FIG. 3, the side rigger 10 comprises a rod holder base 12 as previously described. The rod holder base 12 contains a notch 44 that is adapted to fit around a support member (not illustrated) in the bottom of a standard fishing rod holder 14 to keep the side rigger 10 from turning while installed in the fishing rod holder 14 and to keep the side rigger 10 stable when in use. Actually, two notches 44 are provided on opposites sides of each other on the rod holder base 12 (only one is shown in FIG. 3), since a standard fishing rod holder support member runs across the bottom of fishing rod holder 14, and the two notches 44 create a horizontal space for the support member to fit within to prevent rotation, as is well known.

The rod holder base 12 is angled and contains a neck portion 46. This is because most fishing rod holders 14 on boats 15 are angled. By providing the neck portion 46, it typically allows the platform 16 to rest in a level position with respect to the boat 15 and the water even through the rod holder base 12 is inserted into an angled fishing rod holder 14. The rod holder base 12 contains a mounting member 48 at its top comprised of a disc-shaped member with three threaded orifices 50 and a threaded screw or bolt 52 extending out of the top of the mounting member 48. The threaded screw 52 inserts into a fixed or stationary receiving orifice 54 in the platform 16, and a locking nut 56 attaches to the end of the threaded screw 52 to tighten the mounting member 48, and thus the rod holder base 12, securely to the platform 16.

In accordance with the present invention, it is desirable for the rod holder base 12 to be rotated about the platform 16 so that the orientation of the platform 16, with respect to the boat's rod holder 14 is adjustable since rod holder 14 designs vary from boat to boat. However, it is also desired to limit the amount of rotation so that the platform 16 does not have the ability to rotate 360 degrees around the rod holder base 12 uncontrollably. In order to accomplish this design feature, three threaded orifices 50 are provided on the mounting member 48, wherein one of the three threaded orifices 50 are adapted to receive a threaded screw 58 in order to allow the rod holder base 12 to be rotated about the platform 16. The threaded screw 58 extends through a semi-circle shaped platform grooved orifice 60 and attaches securely to one of the three threaded orifices 50. The platform grooved orifice 60 may allow rotation ±30 degrees from a center position, for example. The grooved orifice 60 may be of any circumference as long as it allows some degree of movement or rotation. The threaded screw 58 contains a head 62 with a cylindrical orifice 64 for receiving a horizontal lever 66 that is used to allow a person to twist or rotate the head 62, thus rotating the threaded screw 58 to loosen the mounting member 48 from the platform 16 to allow the rod holder base 12 to be rotated about the semi-circle shaped platform grooved orifice 60 in order to rotate the position of the rod holder base 12 with respect to the platform 16. For example, the platform grooved orifice 60 may allow rotation ±30 degrees. The amount of rotation is limited by the circumference of the semi-circle platform grooved orifice 60 provided in the platform 16.

In the illustration in FIG. 4, the threaded screw 58 is attached to the center threaded orifice 50, which allows rotation of the platform 16 about the rod holder base 12 left or right with a starting position of 0 degrees, and ±30 degrees for example, if this maximum angle of rotation is provided by the semi-circle shaped platform grooved orifice 60. If more rotation is desired than the maximum allowed by the platform grooved orifice 60 (i.e. the threaded screw 58 is loosened and the platform 16 is rotated so that the threaded screw 58 is adjacent on end of the semi-circled shaped platform grooved orifice 60), the threaded screw 58 can be completely unscrewed from the center threaded orifice 50 and screwed into one of the outside threaded orifices 50. This allows the starting position of the platform 16 rotation with respect to the rod holder base 12 to be offset from 0 degrees, so that rotation of the platform 16 about the rod holder base 12, as limited by semi-circle shaped platform grooved orifice 60, can be rotated further.

For example, if the platform grooved orifice 60 allows rotation by ±30 degrees, and the outside threaded orifice 50 allows fifteen (15) more degrees in offset, then the total rotation can be 45 degrees (30 degrees+15 degree offset). This is particularly important if the rod holder 14 design of a boat requires that the side rigger 10 be rotated to a greater degree of rotation that allowed by the semi-circle shaped platform grooved orifice 60, to keep the platform 16 substantially level.

The additional rod holders 18A, 18B are attached to the platform via an L-shaped member 68, wherein the bottom portion of the L-shaped member 68 is welded to the top of the platform 16, and the side portion of the L-shaped member 68 is welded to the rod holders 18A, 18B.

Lastly, the telescoping pole 24 is mounted to the side rigger 10. The telescoping pole 24 contains two threaded members or screws 70, 72 that extend outward from the pole 24. Threaded screw 72 is adapted to fit in an orifice 73 provided in the adjustable pole mount 26. A locking nut and washer 74 attaches to the threaded screw 72 and securely fits the telescoping pole 24 to the pole mount 26 and thus the side rigger 10.

Just as it is desirable to rotate the rod holder base 12 about the platform 16, it is also desirable to provide for the ability to rotate the telescoping pole 24 outwardly from the platform 16 of the side rigger 10 at varying angles as desired to extend the pole 24 outwardly from the boat 15 up to substantially parallel to the platform 16. This allows the telescoping pole 24 to be extended upward at 0 degrees, as illustrated in FIGS. 3 and 4, when the side rigger 10 is not in use for easier storage, and extended outward from the boat 15 at the angle desired when the side rigger 10 is in use. Rotation ability is provided by the mounting screw 70 being inserted through the semi-circle shaped pole mount grooved orifice 28 provided in the pole mount 26, and securely fastened via a threaded orifice head 76 (like head 62) that is adapted to tighten to the threaded screw 70 with a spring 78 provided therebetween. To rotate the telescoping pole 24, a horizontal member 80, provided through an orifice 82 in the head 76, is rotated to rotate the head 76 to loosen it from the threaded screw 70 to allow the telescoping pole 24 to rotate in either direction about the semi-circle shaped pole mount grooved orifice 28. In this manner, if it is desired to extend the fishing line 22 the maximum distance from the boat 15, and so that the fishing line 22 is closest to the water, the pole 24 is rotated fully to a parallel position to the platform 16. If not, then pole 24 can be rotated to a lesser extent, which brings the line 22 closer to the boat 15 and pulls the line 22 upward off of the water where the pole 24 extends. In this manner, the line 22 will reach the water behind the telescoping pole 24 depending on the angle of rotation.

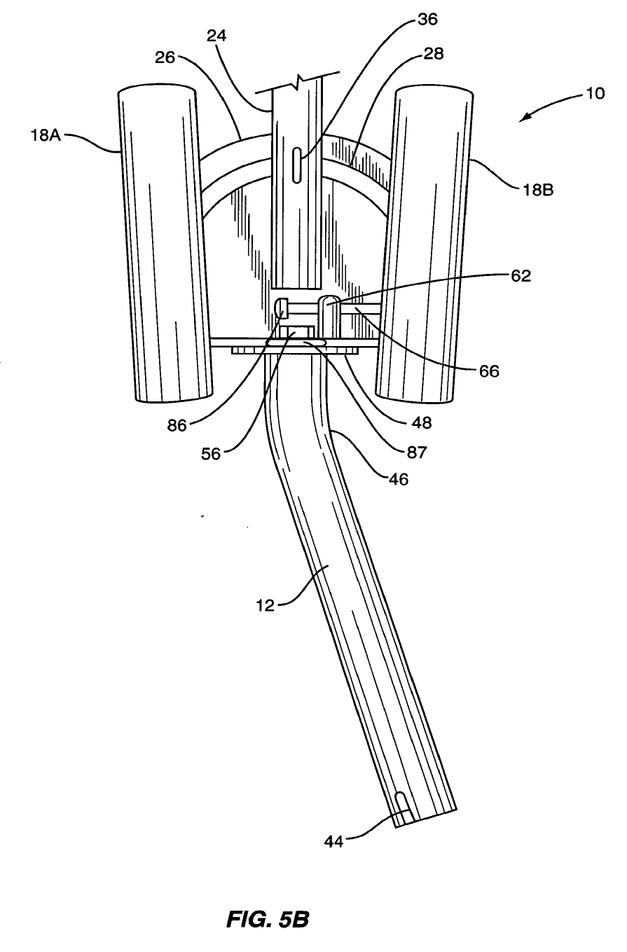

FIGS. 3 and 4 also show the outer conduit 38 and inner conduit 40 in more detail to show the telescoping feature of the telescoping pole 24. To telescope the pole 24, the inner conduit 40 is simply pulled outward and away from the outer conduit 38. So that the inner conduit 40 is not pulled completely out of the outer conduit 38 thereby detaching itself from the side rigger 10. The outer conduit 38 contains an orifice 84 that is adapted to receive a retractable pin 88 (illustrated in FIG. 5) attached on the inner conduit 40, when the pole 24 is fully extended. When the retractable pin 88 reaches the orifice 84, it retracts outward from a retracted position into the orifice 84 to keep the inner conduit 40 from extending farther outward. In order to retract the inner conduit 40 back inside the outer conduit 38, a person presses down on the retractable pin 88 to remove it from the orifice 84, which allows the inner conduit 40 to again move freely inside the outer conduit 38 and the outer conduit 40 to be placed back inside the outer conduit 38.

FIGS. 5A and 5B illustrate the rod holder base 12 rotated about the platform 16, as discussed above for FIGS. 3 and 4, to allow for maximum flexibility to place the platform 16 in the desired position with respect to the rod holder 14. In FIG. 5A, the rod holder base 12 is rotated to the left, by rotating head 62, using horizontal member 66, to loosen the threaded screw 52 from the mounting member 48, and then rotating the rod holder base 12 to the left. The head 62 and threaded screw 52, as attached together, rotate along the semi-circle shaped platform grooved orifice 60 (illustrated in FIG. 3) to allow the rod holder base 12 to rotate to the left with respect to the platform 16. After rotation, the horizontal lever 66 is rotated clockwise to tighten the head 62 against the threaded screw 52 thereby securely tightening the mounting member 48 against the platform 16 so it cannot move. As discussed above, this allows the angle of the rod holder base 12 to be changed with respect to the platform 16 so that the platform 16 can be adjusted and kept level, as desired, depending on the angled variability of fishing rod holders 14 on boats 15.

Similarly in FIG. 5B, the rod holder base 12 is rotated to the right with respect to the platform 16 in the same manner, except the head 62 is rotated in the platform grooved orifice 60 on the right hand side as illustrated. As discussed above, this allows the angle of the rod holder base 12 to be changed with respect to the platform 16 so that the platform 16 can be adjusted and kept level, as desired, depending on the angled variability of fishing rod holders 14 on boats 15.

FIGS. 5A and 5B also illustrate the horizontal lever 66 which contains limiters 86 that have a larger diameter than cylindrical orifice 64 extending through the head 62 so that the horizontal lever 66 does not fall out. The limiter 86 rests against the orifice 64 to keep the horizontal member 66 from escaping from the orifice 64. The horizontal lever 66 can be slid up and down the head 62 to allow for rotation on either side of the head 62 depending on what is most convenient for the person rotating the head 62 and the angle and position of the person doing the rotating. Additionally, a lanyard loop 87 is attached to the platform 15 (shown from a front view) in FIGS. 5A and 5B, so that a lanyard may be attached the loop 87 to prevent loss of the side rigger 10 if the fishing rod holder base 12 becomes unsecured from the fishing rod holder 14.

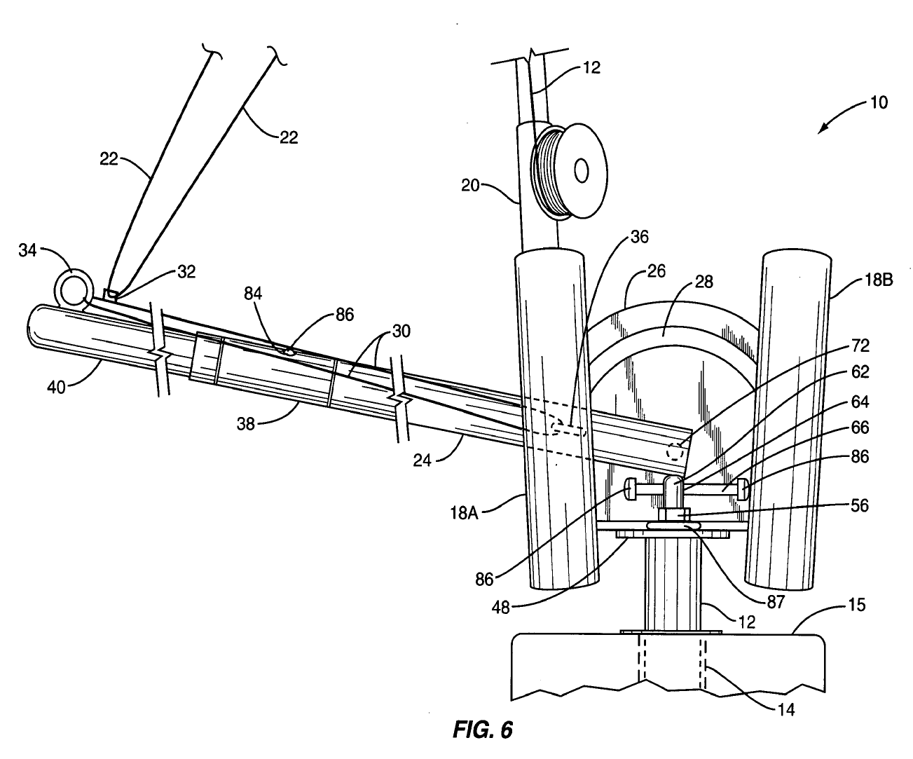

FIG. 6 illustrates the side rigger 10 in use with the telescoping pole 24 fully extended. Note that the retractable pin 88 is extended through the orifice 84 to lock the inner conduit 40 in place with respect to the outer conduit 38. The pole 24 is rotated in the semi-circle shaped pole mount grooved orifice 28 by having loosened the head 76, rotating the pole 24, and tightening the head 76, to firmly secure the pole 24 against the pole mount 26, to almost a parallel position to the platform 16. The fishing rod line 22 extends downward from the top of the fishing rod 20 (not shown), and is attached to the clamp 32, which is attached to the loop line 30. The line 22 then extends back from the pole 24 at the clamp 30 into the water. Thus, the line 22 reaches the water in a position that is extended outward from the boat 15.

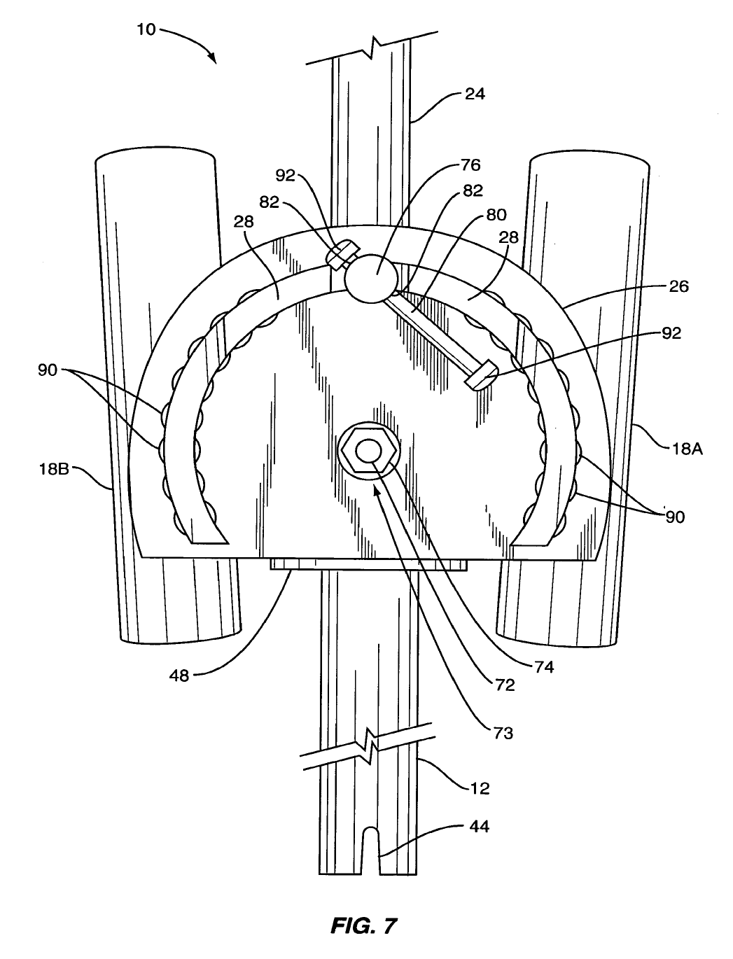

FIG. 7 illustrates the rear view of the side rigger 10 and the rear of the pole mount 26 used to attach the telescoping pole 24 to the side rigger 10. In one embodiment of the present invention, the pole mount 26 contains semi-circle shaped ridges 90 all along the edge of the pole mount grooved orifice 28 to provide for easier positioning of the pole 24 when rotated. The ridges 90 allow one to position the pole 24 in the same location of rotation if desired in a repeatable fashion. The user simply rotates the pole 24 in the pole mount grooved orifice 28 to the desired ridge 90 and then tightens the head 76 to secure the pole 24 firmly against the pole mount 26.

FIG. 7 also illustrates the head 76 and its horizontal member 80 that is used to rotate the head 76 to loosen the head 76 to allow rotation of the pole 24 and securing of same in the desired position about pole mount grooved orifice 28. Similar to horizontal member 66 for rotating the rod holder base 12, the horizontal lever 80 contains limiters 92 that have a larger diameter than orifice 82 extending through the head 76 so that the horizontal member 80 does not escape the orifice 82. The horizontal member 80 can be slid up and down the head 76 to allow for the rotation on either side of the head 76 depending on what is most convenient for the person rotating the head 76 and the angle and position of the person doing the rotating.

It should be noted that the fastener types, angles of rotating, circumferences of grooves, number of additional rod holders provided on the side rigger, and other measurements and sizes shown and illustrated are not limited to the description of one embodiment of the present invention above. Any type of these functions and features may be provided and be within the scope of the present invention.

Those skilled in the art will recognize improvements and modifications to the preferred embodiments of the present invention. All such improvements and modifications are considered within the scope of the concepts disclosed herein and the claims that follow.

1. An adjustably mounted side rigger adapted to be secured inside a fishing rod holder on a boat to extend a fishing line from a fishing rod to a side of the boat, comprising:
a platform containing a platform grooved orifice therein;
a rod holder base having two ends, wherein one end is adapted to be secured inside the fishing rod holder on the boat;
a mounting member attached to the end of the rod holder base opposite from the end adapted to be secured inside the fishing rod holder on the boat;
the platform adjustably attached to the mounting member via a rod holder base fastener attached through the platform grooved orifice and into the mounting member, wherein the rod holder base is adapted to be rotated with respect to the platform by loosening the rod holder base fastener and rotating the rod holder base and rod holder base fastener about the platform grooved orifice; and
a pole attached to the platform via a substantially ±90 degree semicircle grooved orifice in a pole mount that is substantially perpendicular to the platform that is adapted to extend the fishing line from the fishing rod to the side of the boat.

2. The side rigger of claim 1, wherein the rod holder base fastener is attached through the platform grooved orifice into one of a plurality of orifices contained in the mounting member to provide an offset for the rotation of the rod holder base with respect to the platform.

3. The side rigger of claim 2, wherein the platform contains a stationary orifice adapted to receive an additional fastener wherein the additional fastener attaches to a threaded member attached to the mounting member to additionally attach the platform to the mounting member.

4. The side rigger of claim 1, wherein the end of the rod holder base adapted to be secured inside the fishing rod holder on the boat contains at least one notch that is adapted to fit across a support member inside the fishing rod holder to secure the side rigger to the fishing rod holder.

5. The side rigger of claim 1, wherein the rod holder base contains a neck portion adjacent the mounting member.

6. The side rigger of claim 1, wherein one or more rod holders are attached to the platform and are adapted to hold one or more fishing rods in place on the side rigger.

7. The side rigger of claim 1, wherein the platform grooved orifice is semi-circle shaped.

8. The side rigger of claim 1, further comprising a pole mount attached to the platform, wherein the pole mount contains a pole mount grooved orifice, and wherein a pole fastener attached to the pole is adapted to fit through the pole mount grooved orifice to attach the pole to the platform, and wherein the pole is adapted to be extended outward to extend the fishing line from the boat by loosening the pole fastener and rotating the pole about the pole mount grooved orifice.

9. The side rigger of claim 8, wherein the pole mount grooved orifice is semi-circle shaped.

10. The side rigger of claim 8, wherein pole mount contains a mount stationary orifice adapted to receive an additional pole fastener, wherein the additional pole fastener is placed into the mount stationary orifice to additionally attach the pole to the pole mount.

11. The side rigger of claim 8, wherein the pole mount contains a plurality of ridges along the pole mount grooved orifice.

12. The side rigger of claim 1, wherein the pole is a telescoping pole comprised of an inner conduit contained within an outer conduit, wherein the inner conduit is extended from the outer conduit to telescope the pole outward.

13. The side rigger of claim 12, wherein the outer conduit contains an alignment orifice that is adapted to receive a retractable pin attached to the inner conduit when the inner conduit is extended to prevent the inner conduit from being removed from the outer conduit.

14. The side rigger of claim 1, wherein the pole contains an eye hole on each of its ends, wherein the eye holes are adapted to receive a loop line to attach to the fishing line to extend the fishing line outward from the boat along the pole.

15. The side rigger of claim 1, wherein the rod holder base fastener is a threaded shaft attached to the mounting member that is inserted through the platform grooved orifice and inserted into a head having a threaded orifice to secure the mounting member to the platform.

16. The side rigger of claim 15, wherein the head contains a horizontal lever to rotate the head to loosen and fasten the head.

17. The side rigger of claim 8, wherein the pole fastener is comprised of a threaded shaft that placed through the pole mount grooved orifice and inserted into a head having a threaded orifice to secure the pole to the pole mount.

18. The side rigger of claim 17, wherein the head contains a horizontal lever to rotate the head to loosen and fasten the head.

19. The side rigger of claim 17, wherein the platform contains a lanyard loop adapted to receive a lanyard to keep the side rigger from leaving the boat in the event the rod holder base is removed from the fishing rod holder on the boat.

20. A mountable and adjustable side rigger (10), comprising:
a base (12) having two ends, wherein one end is adapted to be secured on a boat (15) to extend a fishing line (22) from a fishing rod (20) to a side of the boat (15);
a mounting member (48) attached to an end of the base (12) opposite the end adapted to be secured on the boat (15);
a platform (16) adjustably and horizontally connected to the base (12) via the mounting member (48) wherein the platform (16) is adapted to be securely positioned around a substantially vertical axis with respect to the base (12);
a pole mount (26) attached substantially perpendicular to the platform (16) and having a substantially ±90 degree semicircle grooved orifice (28) therein; and
a telescoping pole (24) attached to the platform (16) by the substantially ±90 degree semicircle slot (28) that in combination with pole mount (26) is adapted to extend the fishing line from the fishing rod to one side or the other of the boat (15).
